(19) United States
(12) Patent Application Publication
(10) Pub. No.: US 2025/0082997 A1
(43) Pub. Date: Mar. 13, 2025

(54) AUGMENTED REALITY AND ARTIFICIAL INTELLIGENCE SPORTS DATA ANALYTICS SYSTEMS AND METHODS

(71) Applicant: SPORT SPECS INC., Austin, TX (US)

(72) Inventors: Yan Manevich, Austin, TX (US); Vladimir Beliavski, Munich (DE); Sonny Guadarrama, Austin, TX (US)

(21) Appl. No.: 18/290,678

(22) PCT Filed: Jul. 18, 2022
(86) PCT No.: PCT/US2022/073843

§ 371 Date: Jan. 19, 2024

Related U.S. Application Data
(60) Provisional application No. 63/223,262, filed on Jul. 19, 2021.

(51) Int. Cl. A63B 24/00; A63B 71/06

(52) U.S. Cl. CPC A63B 24/0062; A63B 24/0075; A63B 71/0622; A63B 2071/0666; A63B 2220/836

(57) ABSTRACT

An augmented reality sports data analytics system includes a computerized ocular device wearable by a first user. The computerized ocular device has a display screen configured to display a data set within a proximal field of view of the first user without fully obstructing a distal field of view of the first user. An athletic setting is within the distal field of view of the first user. At least one athlete is positioned within the athletic setting. At least one sensor is in communication with the computerized ocular device, the at least one sensor sensing data corresponding to the at least one athlete. A computerized data processing system is in communication with the computerized ocular device and the at least one sensor. The data sensed by the at least one sensor is processed by the computerized data processing system to produce analytical athletic data which is populated into the data set on the display screen of the computerized ocular device.

The present disclosure is generally related to data analytics technology and more particularly is related to augmented reality and artificial intelligence sports data analytics system and methods.

Data analytics is used throughout many industries to analyze underlying data derived from events, places, systems, or other data-producing situations. Within athletics and sport, data analytics is often used to measure an athlete's performance over a particular period of time, such as a baseball athlete's batting average over a season. However, data analytics with sport is often only used to increase performance of the athlete after a sporting event has concluded, where, for example, an athlete can review the data to adjust their performance for a future event. It is rarely, if ever, used in real-time with the sporting event. Further, data analytics with sporting events is commonly inefficient since it relies on human users, such as coaches, assistant coaches, and data analysts, and the like to get relevant data on a player's performance. For instance, data provided to coaches is often done so through a computerized tablet from other coaches or data analysts, but the data is commonly missed since the coaches are watching the sporting events and only view the tablet computers occasionally. Even when coaches have some time to review the data on the table computers, there is often too much data to properly deliver instructions to the athletes during momentary stoppages in play, such as time-outs or half-time.

More complex computer systems with intelligent processing techniques are often used for data analytics, alone, or in combination with the tablet computers conventionally used in athletics. These computer systems may ingest the data and output recommendations or other refined data to the user. However, it is difficult to utilize computer systems in many athletic events, due to the complexities of gaining data from players or sporting implements, such as balls, bats, clubs, etc., which are mobile and not easily adaptable to integrate data transmitters within. As such, data analytics of sporting events is often not available on a real-time basis.

While conventional athletic analytical data devices can be used to assist with limited training of the athletes, they have many shortcomings. For instance, these conventional devices still often provide analytical data to improve an athlete's performance on a one-on-one basis, which cannot accurately imitate real-life situations and experiences. Rather, to create a real-life experience, more than one player must attend, and to work on specific aspects of the game more players must attend. For example, in soccer, to work with defenders, a coach must invite players to imitate opponents. However, the more players that must attend the training, the less efficient the training becomes, and it is more difficult for the coach to organize the session.

Thus, a heretofore unaddressed need exists in the industry to address the aforementioned deficiencies and inadequacies.

Embodiments of the present disclosure provide a system and method for augmented reality sports data analytics. Briefly described, in architecture, one embodiment of the system, among others, can be implemented as follows. An augmented reality sports data analytics system includes a computerized ocular device wearable by a first user. The computerized ocular device has a display screen configured to display a data set within a proximal field of view of the first user without fully obstructing a distal field of view of the first user. An athletic setting is within the distal field of view of the first user. At least one athlete is positioned within the athletic setting. At least one sensor is in communication with the computerized ocular device, the at least one sensor sensing data corresponding to the at least one athlete. A computerized data processing system is in communication with the computerized ocular device and the at least one sensor. The data sensed by the at least one sensor is processed by the computerized data processing system to produce analytical athletic data which is populated into the data set on the display screen of the computerized ocular device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

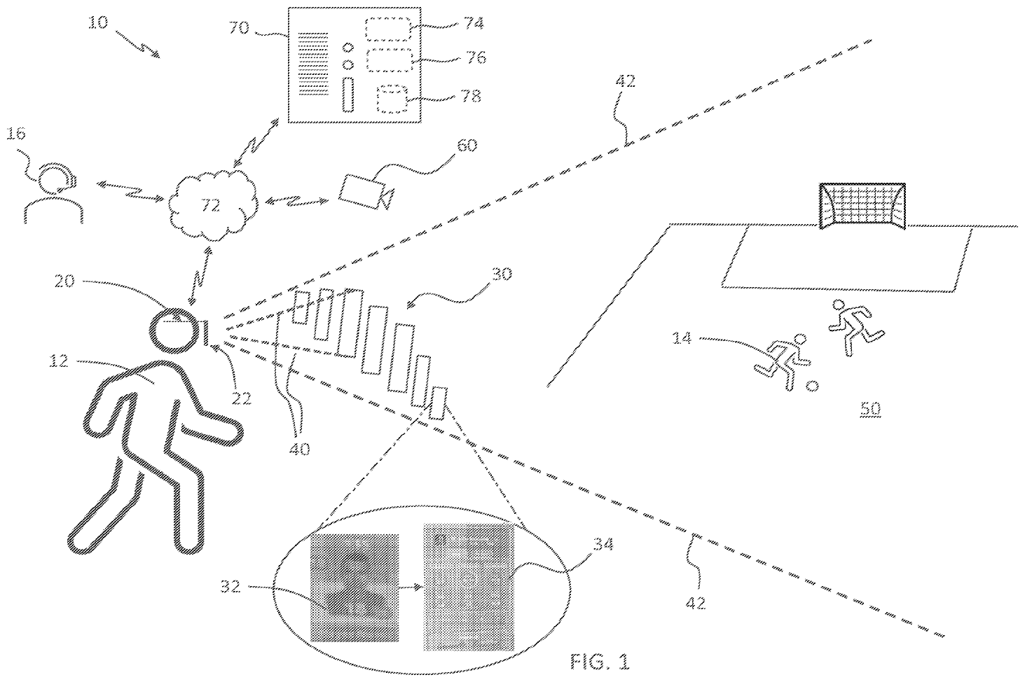

FIG. 1 is a diagrammatical illustration of an augmented reality sports data analytics system, in accordance with a first exemplary embodiment of the present disclosure.

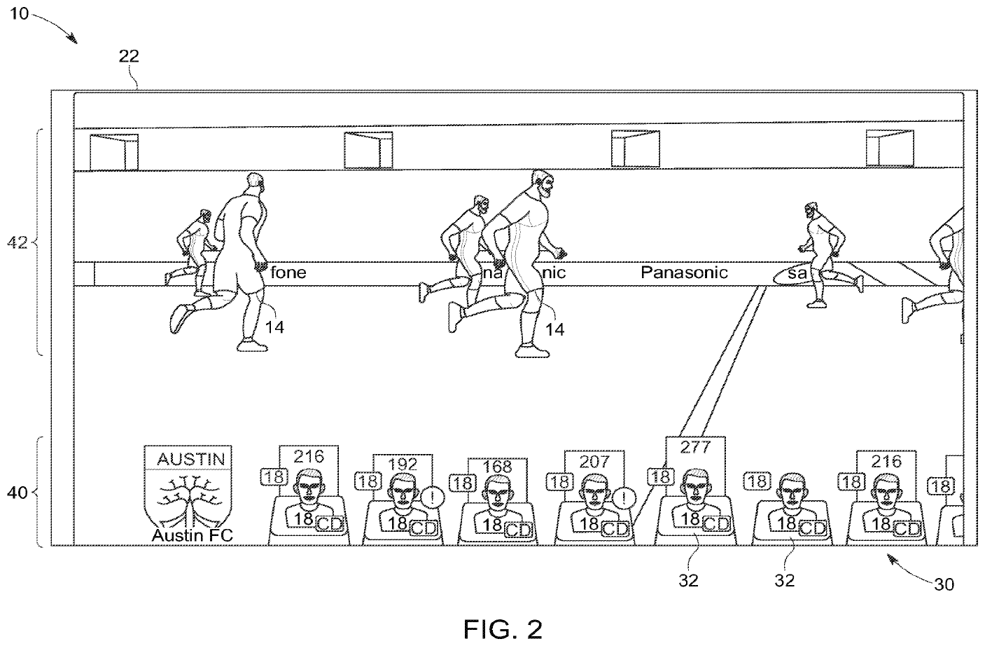

FIG. 2 is a diagrammatical illustration of the augmented reality sports data analytics system of FIG. 1, in accordance with the first exemplary embodiment of the present disclosure.

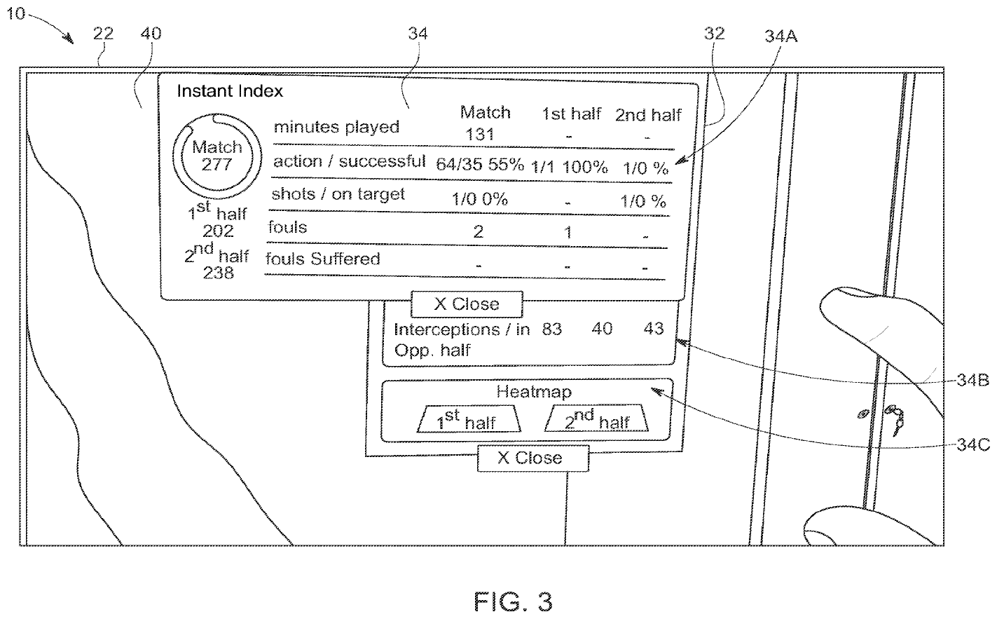

FIG. 3 is a diagrammatical illustration of the augmented reality sports data analytics system of FIG. 1, in accordance with the first exemplary embodiment of the present disclosure.

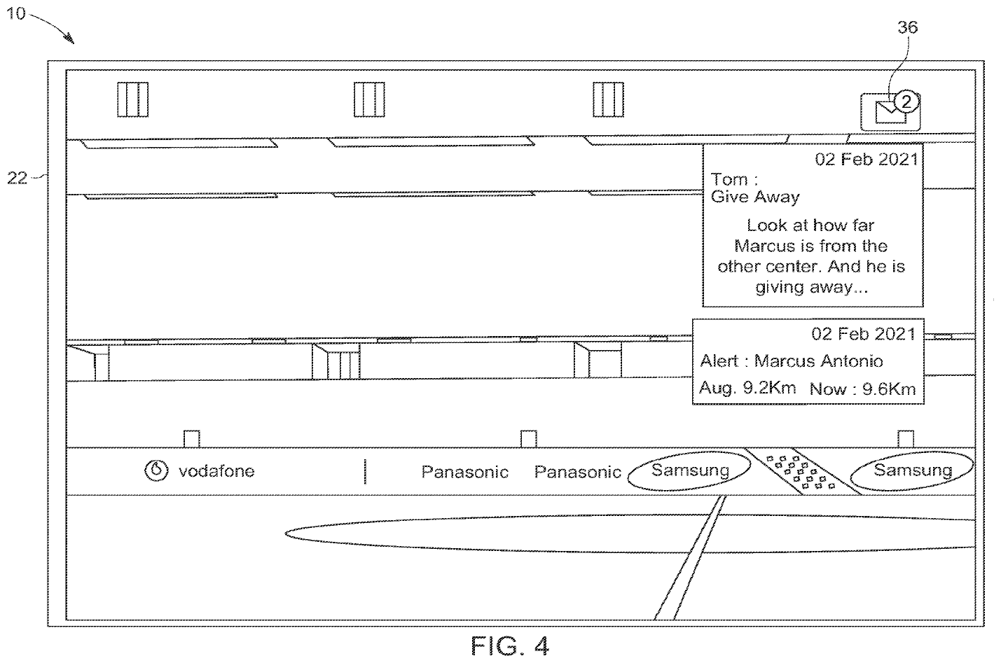

FIGS. 4-6 are diagrammatical illustrations of the augmented reality sports data analytics system of FIG. 1, in accordance with the first exemplary embodiment of the present disclosure.

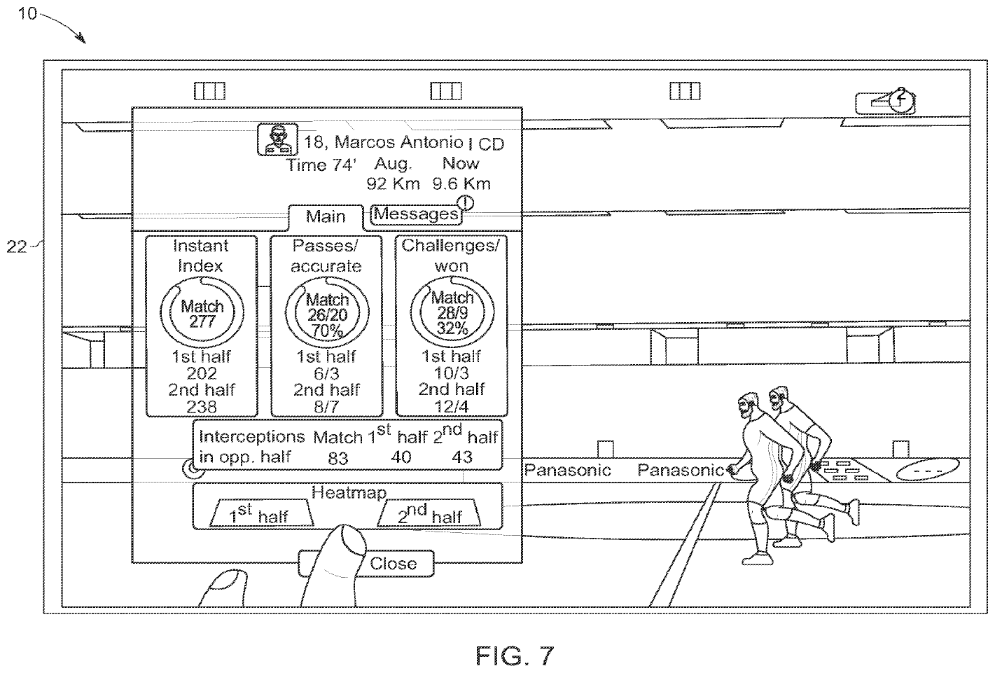

FIGS. 7-11 are diagrammatical illustrations of the augmented reality sports data analytics system of FIG. 1, in accordance with the first exemplary embodiment of the present disclosure.

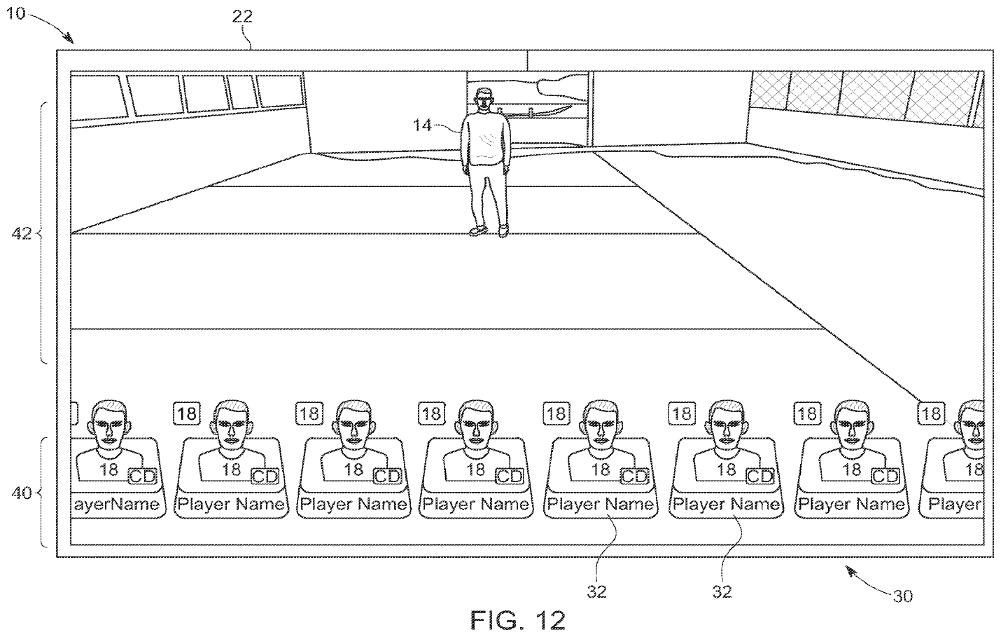

FIGS. 12-21 are diagrammatical illustrations of the augmented reality sports data analytics system of FIG. 1, in accordance with the first exemplary embodiment of the present disclosure.

To improve over the conventional art and provide more accurate delivery of analytics for sporting events in real-time or near real-time, the present disclosure provides an augmented reality sports data analytics system, methods, and related apparatuses. As discussed herein, the present disclosure can improve on analytical data for sporting events by generating augmented reality in-game data, which coaches can use to provide instructions to athletes. Similar, the present disclosure can be used for athletic training situations to improve the athlete's ability to train in simulated situations which closely match real game play.

FIG. 1 is a diagrammatical illustration of the augmented reality sports data analytics system 10, in accordance with a first exemplary embodiment of the present disclosure. The augmented reality sports data analytics system 10, which may be referred to as ‘system 10’ within this disclosure, includes a computerized ocular device 20 wearable by a first user 12. As shown in FIG. 1, the computerized ocular device 20 may be worn by the first user 12, such as on their head or around their face, whereby a display screen 22 of the computerized ocular device 20 is positioned substantially aligned with one or more of the eyes of the first user 12. The specific type of computerized ocular device 20 may vary, and may include, for example, glasses, goggles, a visor, or similar wearable implement.

The display screen 22 of the computerized ocular device 20 is configured to display a data set 30 within a proximal field of view 40 of the first user without fully obstructing a distal field of view 42 of the first user 12. The proximal field of view 40 the first user 12 may generally be one or more portions of the first user's 12 immediate field of view, such as that which corresponds to locations near the eye of the first user 12. In contrast, the distal field of view 42 of the first user 12 may correspond to a further away field of view of the first user 12, such as a field of view which is located the distance away from the first user 12. While the specific dimensions corresponding to the proximal field of view 40 and the distal field of view 42 may vary, in one example, the proximal field of view 40 may be within inches of the eyes of the first user 12, whereas the distal field of view 42 may be five or more feet away from the first user 12, and more preferably, many feet away from the first user 12, such as tens or hundreds of feet. This configuration may correspond to the location where the first user 12 would be positioned as a coach or an assistant coach at an athletic event, where the distal field of view 42 is the athletic setting 50 for the field of play for the athlete 14.

It is also noted that the athletic setting 50 may include any type of athletic or sporting venue, such as a field, a park, a green, a swimming pool, a court, or another athletic venue, and the present invention can be used with any type of sporting or athletic event. For clarity in describing the invention, soccer (or football outside of the U.S.) is used as an exemplary sport within this disclosure, where the first user 12 is a coach or an assistant coach, the athlete 14 is one or more of the soccer athletes, and the athletic setting 50 is a soccer field. As shown in FIG. 1, the first user 12 may be positioned proximate to the athletic setting 50, such that when the first user 12 is wearing the computerized ocular device 20, he or she can maintain a visual line of sight to the athletic setting 50, and to the athletes 14 positioned thereon. The first user 12 can also see the data set 30 which is displayed on the display device 22 of the computerized ocular device 20, such that the first user 12 can maintain a simultaneous or near simultaneous view both the proximal field of view 40 and the distal field of view 42.

The system 10 may further include one or more sensors 60 to sensor data from the athletic setting 50, from the athletes 14, or from another individual or object involved with the sport, such as a sporting implement. The one or more sensors 60 may include any type of sensor, such as a visual sensor (camera, photo eye, LIDAR, etc.), a movement or position sensor (accelerometer, GPS chip, etc.), a proximity sensor (NFC, RFID, Bluetooth, etc.), a thermal sensor, a biometric sensor, or any other type of sensor. The one or more sensors 60 may be located at various locations around the athletic setting 50, such as within the field of play, next to the field of play, in an elevated position around the field of play, or in another appropriate location. Additionally, one or more sensors 60 may be positioned within the computerized ocular device 20 itself. One more sensor 60 may also be worn by an athlete 14, such as when a biometric sensor is integrated into a wristband or similar wearable device by the athlete 14. While one sensor 60 is depicted in FIG. 1 for simplicity and disclosure, it may be common to use a plurality of sensors 60 in different locations about the athletic setting 50, within the computerized ocular device 20, within a sporting implement, and/or on one or more of the athletes 14, any combination of which is considered within the scope of the present disclosure.

During an athletic event, whether a game or a practice, the one or more sensors 60 will send data which corresponds to some aspect of the athletic event. This may include sensing data about the at least one athlete 14, about the sporting implement, about the field of play within the athletic setting 50, about an environmental condition which can affect the sporting event, etc. As an example, the data sensed by the one or more sensors 60 may be the distance an athlete 14 travels on the field of play during a period of time, such as a quarter or half of a soccer game. The system 10 may identify this data based on a GPS chip in which is carried by the athlete 14, such that the positioning of the athlete 14 over the duration of the period of time can be mapped and accumulated distance traveled by the athlete 14 can be determined. In a similar example, the system 10 can determine a position or location of the athlete 14 within the field of play and a corresponding time of how long that athlete 14 was present in that location, whereby the system 10 can effectively determine the cumulated positioning data of that athlete 14.

The system 10 further includes a computerized data processing system 70, which is in communication with the computerized ocular device 20 and the at least one sensor 60. As shown in FIG. 1, the computerized data processing system 70 may be a server or other computing device having a memory 74, a processor 76, and a database 78 for storing and processing electronic data. The computerized data processing system 70 is connected to the computerized ocular device 20 and the at least one sensor 60 with a network 72, such as the Internet, a LAN, a cloud computing network, or similar wired or wireless communication network. The data sensed by the at least one sensor 60 is communicated to the computerized data processing system 70 where it is processed to produce analytical athletic data. The analytical athletic data may then be communicated to the computerized ocular device 20, where it is populated into the data set 30 on the display screen 22 of the computerized ocular device 20, such that the first user 12 can view the analytical athletic data.

It is noted that the analytical athletic data may include a variety of types of data, including alphanumerical data, image or visual data, biometric data, or other data, all of which is considered within the scope of the present disclosure. Moreover, the format of the analytical athletic data may vary depending on the design and use of the system 10. FIGS. 2-21 depict various images of different types of analytical athletic data. As an exemplary depiction in FIG. 1, the analytical athletic data may correspond to different players within an athletic team, whereby the data set 30 provides a tile 32 corresponding to each of the athletes 14. For example, FIG. 1, depicts a detailed view of the data set 30 depicting one tile 32 which has analytical athletic data 34 thereon, or accessible by selecting various data points within the tile 32.

The system 10 may offer benefits for both providing in-game analytical data and with practice sessions to provide data to coaches and/or to provide simulated training scenarios for athletes. To this end, the components and functionality of the system 10 is described in further detail in FIGS. 2-21 relative to either in-game management or training and practice scenarios, but the components and functionality described may apply to both in-game management and training and practice scenarios equally.

With in-game management in particular, the system 10 is arranged with the head coach wearing the computerized ocular device 20 such that he or she can receive all the data without taking eyes away from the field of play. This helps ensure that no data is missed, and all the data is current. The head coach may store necessary data to brief the players at half-time, to use the half-time period more efficiently. The head coach can also communicate with the assistant coaches and/or data analysts 16 through the audio channel implemented in the computerized ocular device 20, as shown in FIG. 1. This allows the head coach to make decisions faster and more efficiently.

FIG. 2 is a diagrammatical illustration of the augmented reality sports data analytics system 10 of FIG. 1, in accordance with the first exemplary embodiment of the present disclosure. FIG. 3 is a diagrammatical illustration of the augmented reality sports data analytics system 10 of FIG. 1, in accordance with the first exemplary embodiment of the present disclosure. Both FIGS. 2-3 illustrate the system being used for in-game management. With reference to FIGS. 1-3 together, FIGS. 2-3 depict a portion of the display screen 22 as a first user 12 would view when using the system 10. FIG. 2 shows the display screen 22 with the proximal field of view 40 in the distal field of view 42 depicted. As can be seen in the proximal field of view 40, the first user 12 computes the data set 30 having various tiles 32 corresponding to athletes 14. The tiles 32 may be pop-up augmented reality displays which contain information and data about the athlete 14, a team, or another aspect of the sport.

FIG. 3 illustrates the first user's 12 view within their proximal field of view 40 when they're wearing the computerized ocular device 20 within the system 10. On the display screen 22, the user would visually see one or more portions of the data set 30, such as, one or more tiles 32 which have analytical athletic data 34 thereon. As previously discussed, this analytical athletic data 34 can be presented in various formats, such as in a chart 34A having numerical and statistical data, alphanumeric data corresponding to different time periods within the athletic event, as shown at 34B, or graphical data such as a heatmap or graph as shown at 34C. The first user 12 can interact with the analytical athletic data 34 within the tiles 32 with various methods, such as, for example, using their fingers in a particular motion to select data or other portions of the augmented reality display.

The analytical athletic data 34 can include any type of data pertaining to the sport. For example, with soccer, the analytical athletic data 34 can include metrics, statistics, playing time, in-game performance, such as passes, fouls, or cross-kicks, position heat maps, GPS-based location data, etc., whether reactive or proactive. It is also possible to process the analytical athletic data 34 with artificial intelligence processing algorithms to provide suggestions to the first user 12, such as based on pre-game preparations, etc. The analytical athletic data 34 can also include benchmarks on player data corresponding to a type of play. For example, this benchmark data may provide a historical average distance ran during a game by a defensive player, or a historical average distance ran during a game by an offensive player, such that future or current performance of the defensive or offensive player can be compared to past benchmarks.

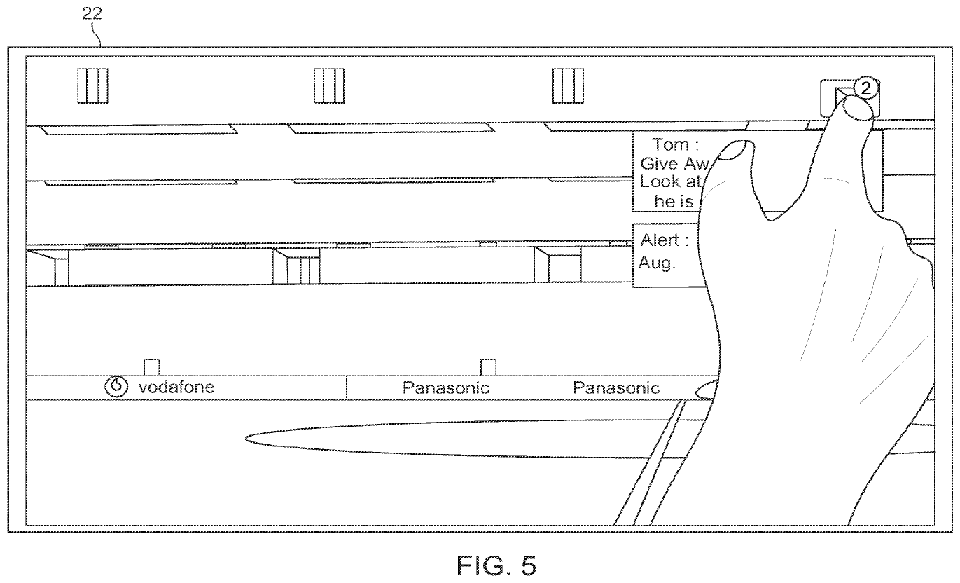

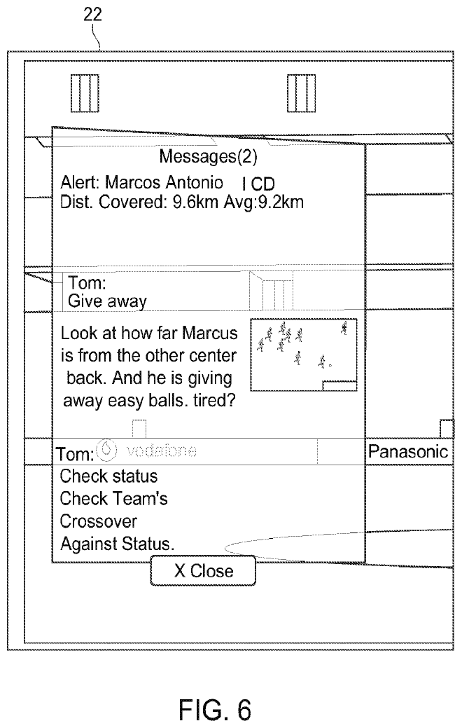

FIGS. 4-6 are diagrammatical illustrations of the augmented reality sports data analytics system 10 of FIG. 1, in accordance with the first exemplary embodiment of the present disclosure. With reference to FIGS. 1-6 together, FIGS. 4-6 depict the interface of the system 10 where the first user 12 can receive and review messages from assistance coaches or data analysts 16, such as reports, suggestions, instructions, or other data pertaining to the athletic event. As shown in FIG. 4, the display screen 22 can depict various icons in the first user's 12 proximal field of view 40, such as a messages icon 36. The first user 12 selects the messages icon 36, as is shown in FIG. 5, which acts to open up a new tile displaying the messages, as shown in FIG. 6. In this way, the first user 12 can communicate with assistant coaches or data analyst 16 directly within the display screen 22, without removing their visual attention from the field of play in the distal field of view 42. The messages may include textual data, video clips, audio clips, such as voice messages with or without speech-to-text capabilities, graphical data, or other types of data, and the messages can be communicated in to and from any people using the system 10.

It is noted that while coaches and assistant coaches may be present at the location of the athletic event, the data analysts may be located anywhere and still be able to communicate through the system 10. The system 10 also allows the communication of graphical data between the head coach and the assistant coaches or data analysts 16, which is often not able to be communicated precisely through conventional auditory only communication, such as phone calls.

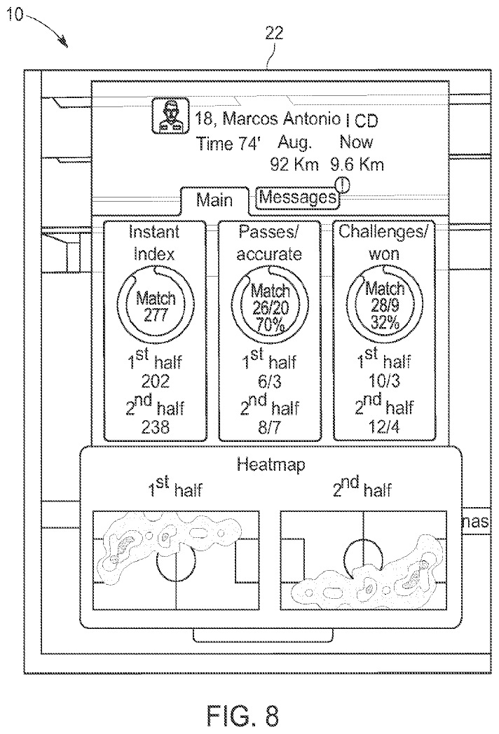

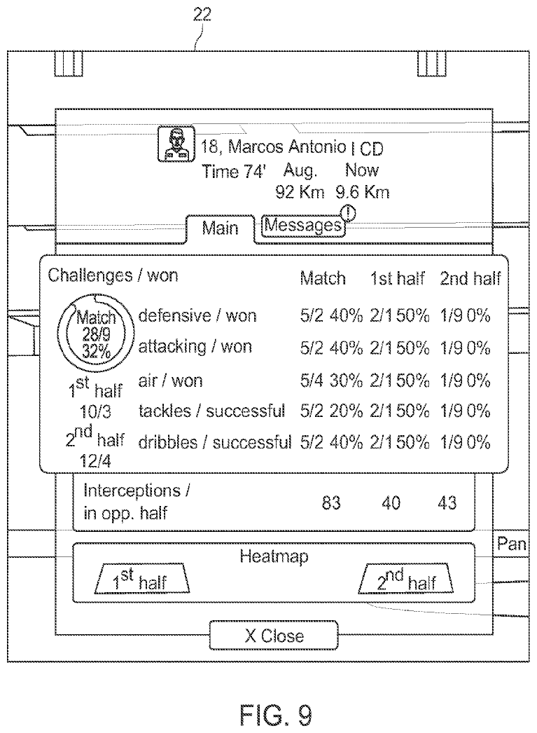

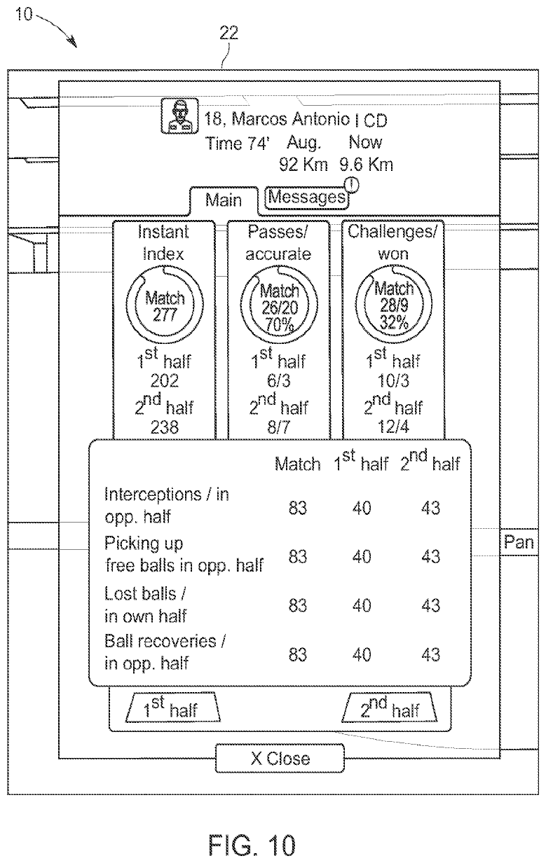

FIGS. 7-11 are diagrammatical illustrations of the augmented reality sports data analytics system 10 of FIG. 1, in accordance with the first exemplary embodiment of the present disclosure. With reference to FIGS. 1-3 and 7-11 together, it can be seen how the system 10 can be used by the head coach to retrieve analytical athletic data about an athlete 14 without removing their visual attention from the distal field of view 42. For example, in FIG. 7, the head coach may select a tile 32 which corresponds to a particular athlete 14. The head coach may then select different analytical data sections within that tile 32. For example, as shown in FIG. 8, head coach may select a heat map depicting graphical images of the athlete's 14 location within different time periods of the game such as within the first half and the second half. Graphical heatmap may show the athlete's 14 location using differently colored indicators on the display 22, such that the head coach can quickly identify accumulative locations of the athlete 14 throughout the game. In FIG. 9, the head coach may select numerical data corresponding to the player's performance throughout the game, such as the challenges won or lost by the athlete during the game, for instance, defensive or offensive wins, or specific athletic moves, such as on-goal shots, dribbling, headers, or similar athletic movements in soccer. FIG. 10 depicts the head coach viewing numerical data showing statistical information about the athlete 14 is organized by different time periods within the game.

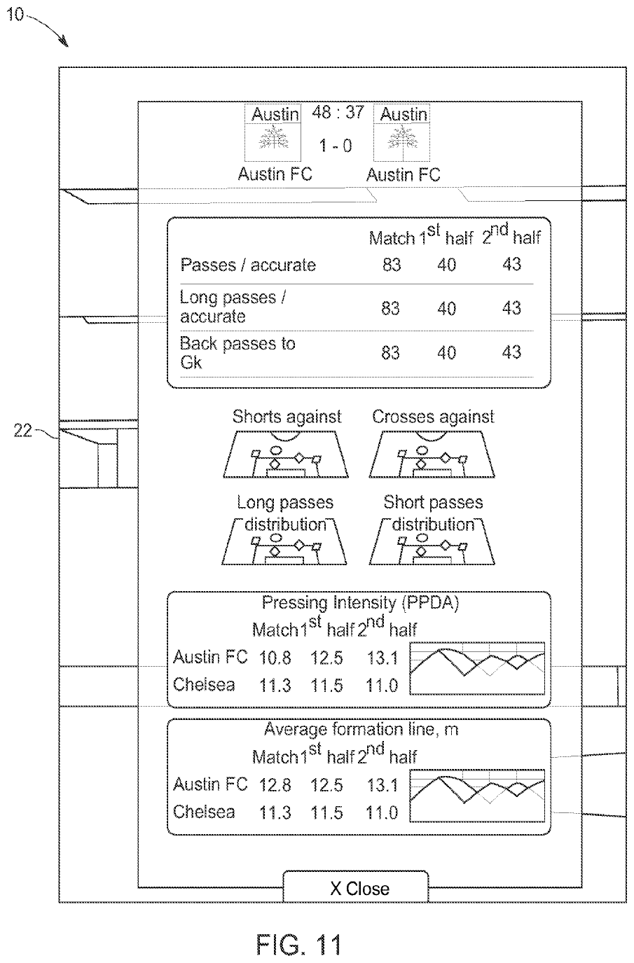

In a similar fashion to FIGS. 8-10, FIG. 11 depicts analytical athletic data corresponding to more than one athlete 14. In particular, FIG. 11 depicts team-wide analytical athletic data which is produced by the system 10, such that the head coach can view alphanumerical, graphical, in statistical data of the team effort within a particular game. This may include data about the shots taken, crosses in front of a goal, long past distribution, short pass distribution, pressing intensity, and average formation line, among other data points. Similar to as described previously, all of the team-wide data can be viewable by the head coach on the display screen 22 without removing their visual attention from the distal field of view 42. This ensures that the head coach can receive all relevant data about the performance of either an individual athlete 14 or a team, without negatively affecting the head coaches attention towards the active game.

Turning now to FIGS. 12-21, these figures depict features and functionality of the system 10 during training or practice modes, where the system 10 is used during non-game times to aid with instructing or coaching athletes 14. Training modes of the system 10 may first include the first user 12 (coach) providing the athlete 14 with a computerized ocular device 20 and then sending training exercises to that athlete's 14 ocular device 20. The coach then sets up the drill (either manually or by choosing a pre-set one), using 3D models as opponents. The athlete 14 sees in computerized ocular device 20 the 3D model imitating the opponent. The coach can record the drill from his/her computerized ocular device 20 and after the drill, discuss the athlete's 14 actions with that athlete 14.

It is noted that the training scenarios can leverage artificial intelligence processing and algorithms, such that coaches can create virtually any scenario for training scenarios, include 1 vs. 1, 2 vs. 2, defensive drills, free kicks with walls, designed plays, attacks, defensive plays, etc. It is further noted that with the practice drills for the athletes 14, it is possible for the coach to adjust the parameters as needed. For example, with a free kicks drill with a wall made from virtual players, it may be possible for the coach to adjust the number of virtual players in the wall, the height of the wall, whether the virtual players jump up when the athlete 14 kicks the ball, etc.

FIGS. 12-19 are diagrammatical illustrations of the augmented reality sports data analytics system 10 of FIG. 1, in accordance with the first exemplary embodiment of the present disclosure which shows the view of the first user 12 on the display screen 22. With reference to FIGS. 1-2 and 12-19, the first user 12 is visually presented with the display screen 22 which depicts the proximal field of view 40 in the distal field of view 42. In FIG. 12, the first user 12 can see the athlete 14 within the distal field of view, such as when the athlete is on the field and in the proximal field of view 40, first user 12 can see the data set 30 having different tiles 32 corresponding to each of the players on the team that the first user 12 is coaching.

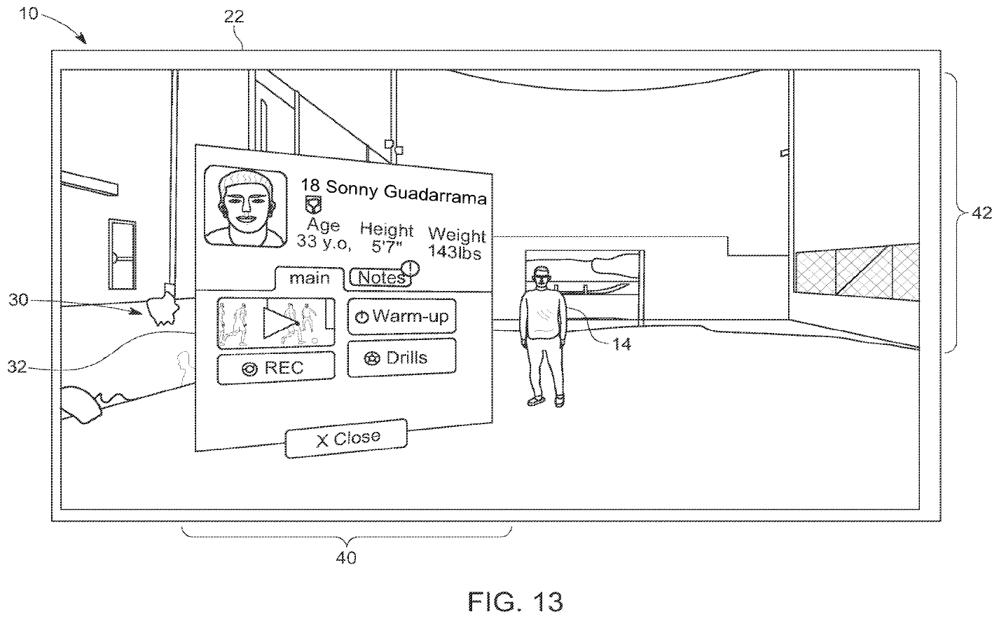

In one example, as shown in FIG. 13, the first user 12 may select one of the tiles 32 corresponding to one athlete 14. The display screen 22 may then depict a new tile with the athlete's 14 name as an image, as well as biographical information about the athlete 14, such as age, height, weight, or other data. The first user 12 may then select the type of training mode to use with this athlete 14. The system 10 may display various training modes within the tile 32, or within another format visually displayed on the display screen 22, whereby the first user can select the desired training mode. The system 10 may further display historical information about the athlete 14, such as video data of the athlete's 14 performance during a previous athletic event, such that the first user 12 can have readily accessible information about where the athlete 14 may need specific instruction or training

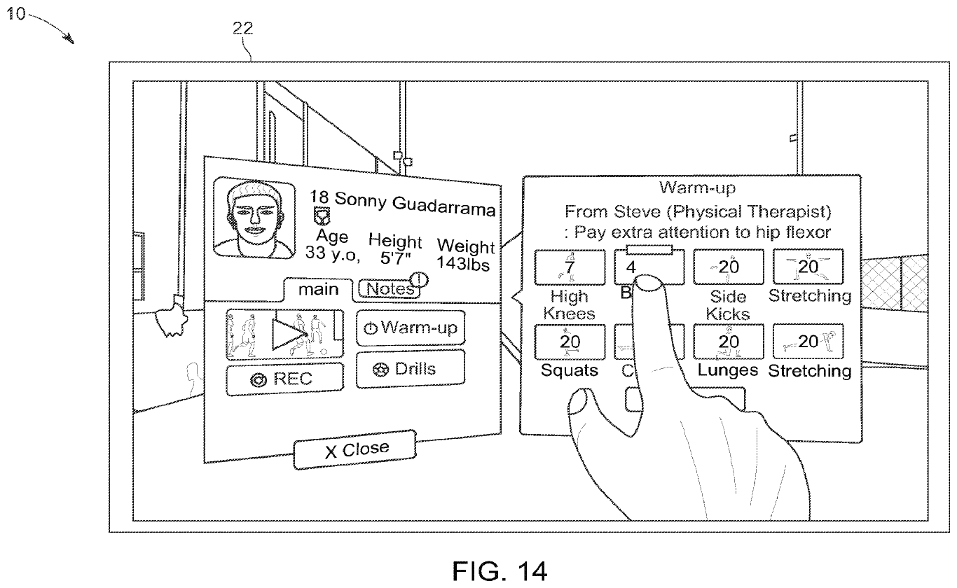

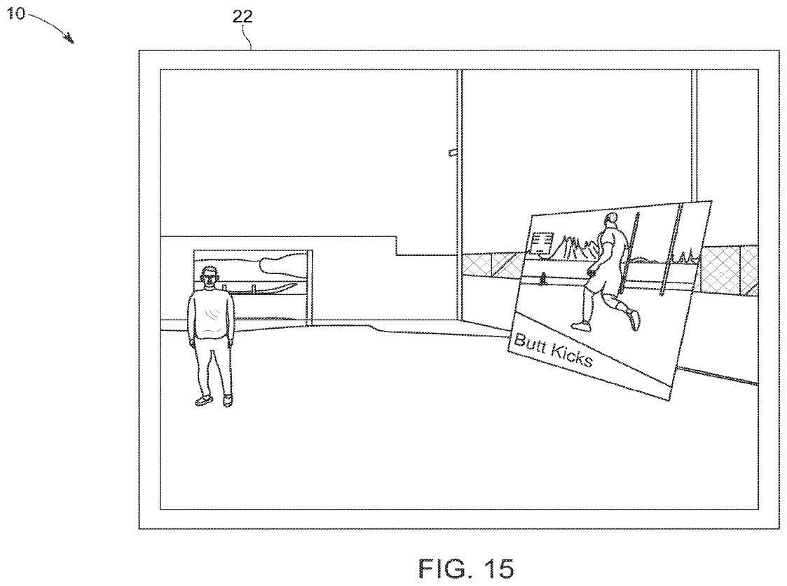

Next, as shown in FIG. 14, the display screen 22 illustrates the first user 12 selecting a warm-up training mode. The warm-up mode may be one of many different types of training modes that can be selected by the first user 12. The warm-up training mode may be selected by the first user 12 by using their finger or other implement to interact with the augmented field depicted on the display screen 22. This action may open up another tile which depicts different types of warm-up scenarios that can be used for training. The first user may select one of the warm-up scenarios, such as, in the example shown in FIGS. 14-15, a butt kicks training scenario, where the athlete 14 raises his or her feet upwards towards their butt. Once the specific scenario is selected, the first user 12 may visually see an instructional video displayed on the display screen 22 within the proximal field of view 40, or the instructional video depicts the training exercise. The first user 12 can then verbally instruct the athlete 14 to perform the training exercise, or as discussed further within this disclosure, the athlete 14 may also have a computerized ocular device 20 which provides them with visual instructions for the training exercise.

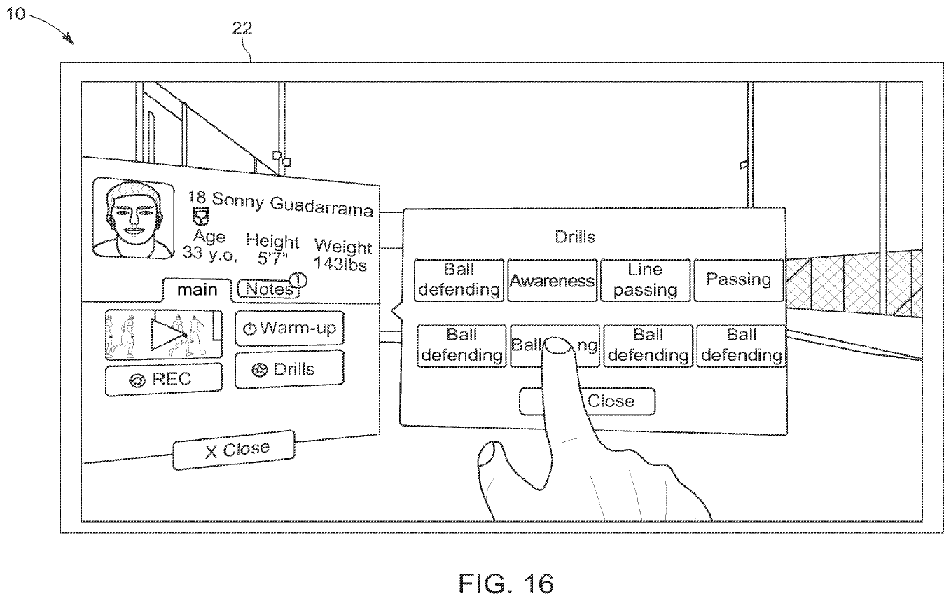

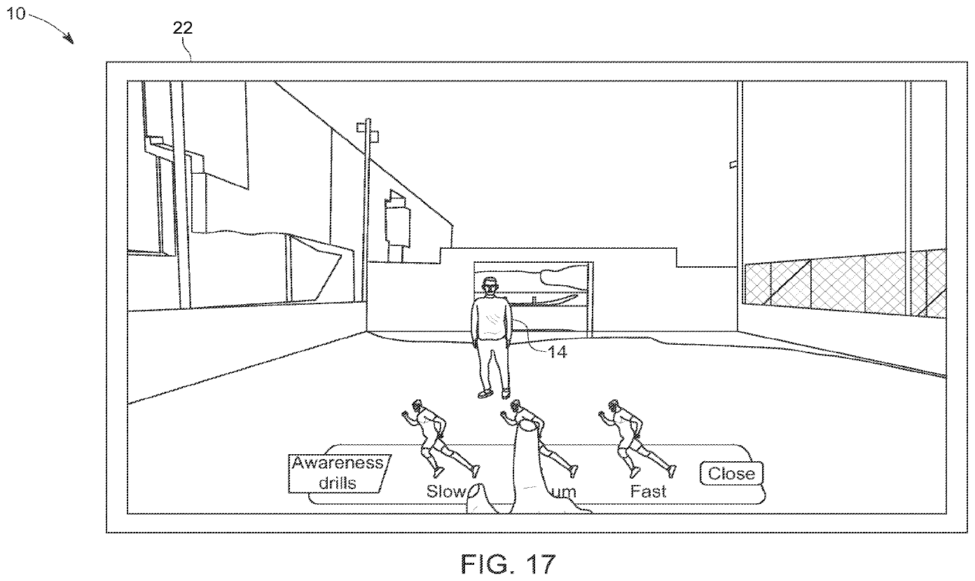

FIGS. 16-19 depict a similar situation to that in FIGS. 14-15. Specifically, FIG. 16 depicts the first user 12 selecting from a ‘drills’ menu on the display screen 22. Once the appropriate drills icon is selected, a new tile having all of the drills options may be presented to the first user 12 whereby the first user 12 can select the desired drill. After selection of the desired drill, the first user 12 may be able to select particular parameters of that drill. For example, as shown in FIG. 17, the first user 12 may select the speed of the drill, for example, slow, medium, or fast. It is noted that various parameters or adjustments may be made by the first user 12 beyond speed. For example, adjustments to difficulty, intensity, environmental conditions, setting, or any other characteristic or parameter about the sport may be made by the system 10, all of which are considered within the scope of the present disclosure.

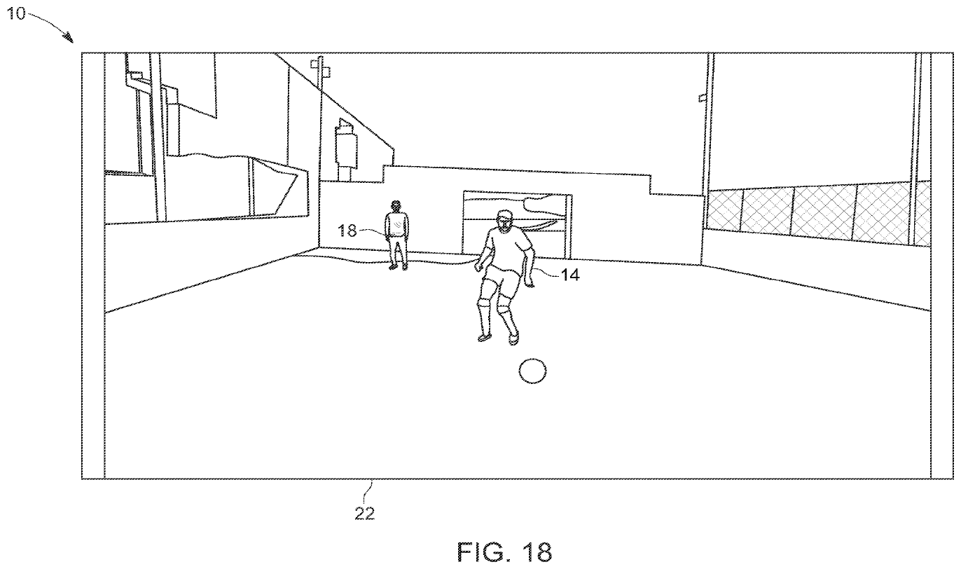

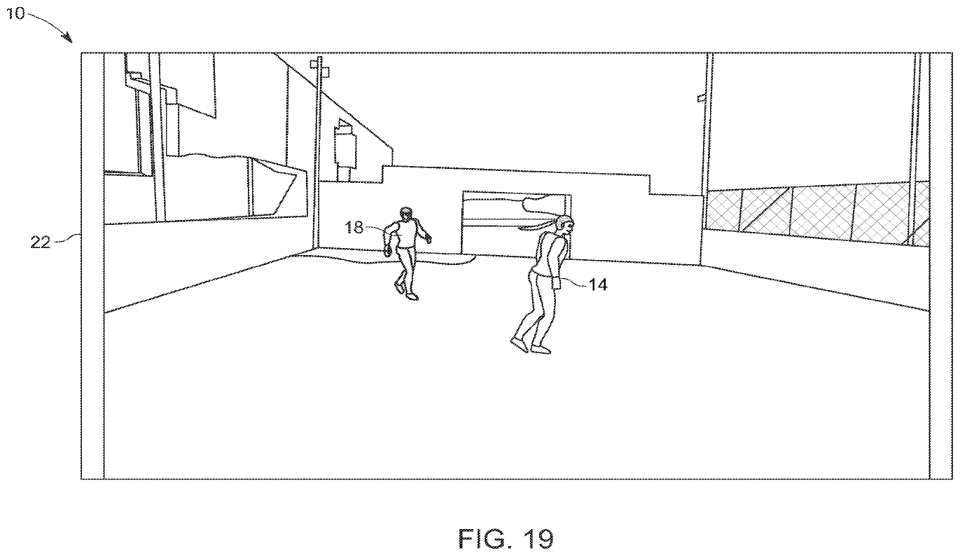

Next, as shown in FIG. 18, the system 10 activates the drill for the athlete 14. The athlete will have on a computerized ocular device 20 such that they can view the augmented reality environment provided by the system. When the drill is activated, the first user can visually see on the display screen 22 a mixed reality athlete 18 positioned within the distal field of view 42, in a location near the human athlete 14. As the drill progresses, in this example, the system 10 activates the mixed reality athlete 18 to move towards human athlete 14, as shown in FIG. 19.

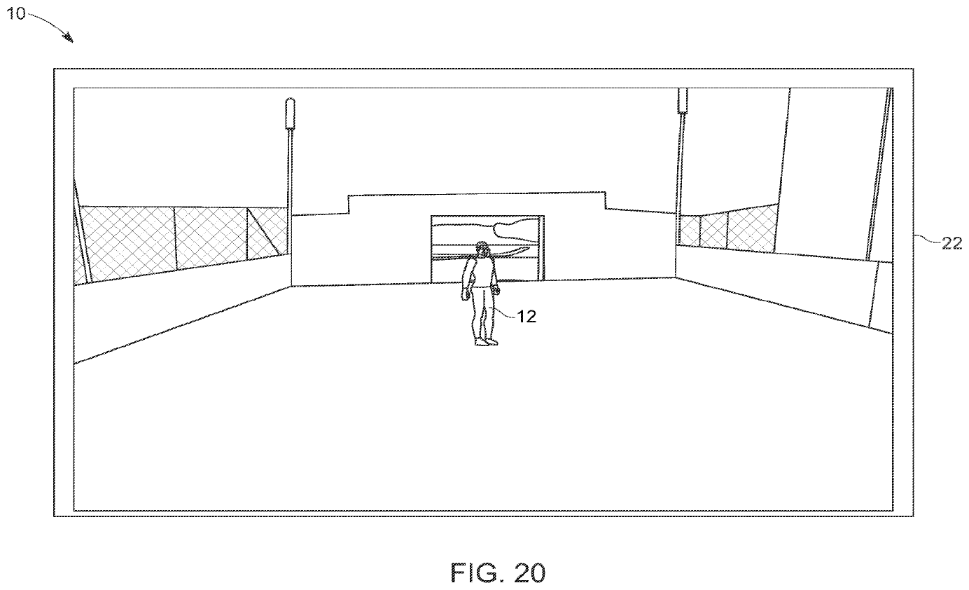

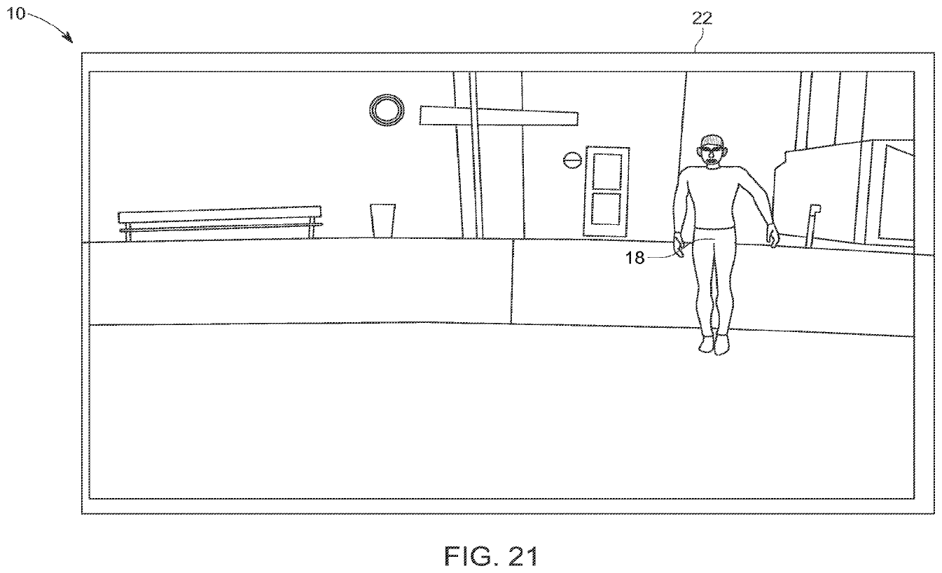

For the drills scenario described in FIGS. 16-19, the corresponding athlete 14 view within the system 10 can be seen in FIGS. 20-21. In particular, as shown in FIG. 20, the display screen 22 of the computerized ocular device 20 that the athlete 14 is wearing is shown depicting the field of play with the first user 12 position within the distal field of view 42. In this example, the drill is an awareness drill where the mixed reality athlete 18 comes from behind the athlete 14, such that in the view depicted in FIG. 20, the athlete 14 cannot see the mixed reality athlete 18 yet. However, as the athlete 14 turns his or her head, the location of the distal field of view 42 changes and the mixed reality athlete 18 is depicted for the athlete 14. This is shown in FIG. 21. As the athlete 14 sees the mixed reality athlete 18 approaching as the athlete 14 checks his or her shoulder, the athlete 14, on the field of practice, can physically move out of the way of the oncoming mixed reality player 18. In this way the athlete 14 can practice the particular maneuver within the drill against a virtual opponent. Throughout the drill, the first user 12 (the coach) can view the drill to see the athlete 14 and their performance. It is also possible for the first user 12 to view the drill from different points of view, such as from the athlete's 14 point of view.

The present disclosure provides specific examples relative to in-game or training scenarios, but it is noted that there is a near unlimited number of different in-game or training scenarios that may be employed by the system 10. These in-game or training scenarios may include any scenario which is the same or similar as used conventionally in the athletic event itself, all of which are considered within the scope of the present disclosure. For instance, drills can include any number of human athletes 14 or mixed reality athletes 18, with any setting or situation, and practicing any aspect of the sport.

The system 10 may also function by recreating drills for athletes 14 which are based on the practices and exercises used by leading athletes within the sport. For instance, in soccer, the system 10 can model drills after those used by leading soccer players around the World, such that any athlete 14 can use the system 10 to train like a professional athlete. These various drills can be set up in a digital marketplace in the system 10, where coaches or athletes can pay for specific drills which are uploaded to the system 10, or athletes can upload drills to the system 10 and receive incentives, monetary or otherwise, for providing drills.

Additionally, the system 10 could be used for scouting athletes. For example, athletes can use the system 10, and the system 10 can use AI algorithms to identify the skill level of athletes, such that scouts can use the system 10 to find top athletes. In another example, a scout can wear the computerized ocular device 20 while a player wears sensors on his or her body or equipment. As the athlete 14 is put through drills, the video of the athlete's 14 performance can be sent to coaches or other parties located in remote places, such as in other countries. The scout can also record notes, take images or videos, etc. through the system 10, which can be uploaded to scouting databases.

It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

The following numbered examples are embodiments:
1. An augmented reality sports data analytics system comprising:
   a computerized ocular device wearable by a first user, the computerized ocular device having a display screen configured to display a data set within a proximal field of view of the first user without fully obstructing a distal field of view of the first user;
   an athletic setting within the distal field of view of the first user, wherein at least one athlete is positioned within the athletic setting;
   at least one sensor in communication with the computerized ocular device, the at least one sensor sensing data corresponding to the at least one athlete; and
   a computerized data processing system in communication with the computerized ocular device and the at least one sensor, wherein the data sensed by the at least one sensor is processed by the computerized data processing system to produce analytical athletic data, wherein the analytical athletic data is populated into the data set on the display screen of the computerized ocular device.
2. The system of example 1, wherein the at least one sensor is positioned on or in the athletic setting, the at least one athlete, or a sporting implement.
3. The system of examples 1 or 2, wherein the at least one sensor is at least one of: a visual sensor, a movement or position sensor, a proximity sensor, a thermal sensor, or a biometric sensor.
4. The system of examples 1, 2, or 3, wherein the analytical athletic data further comprises at least one of: data about the at least one athlete, a sporting implement, a field of play within the athletic setting, an environmental condition which can affect a sporting event.
5. The system of examples 1, 2, 3, or 4, wherein the analytical athletic data corresponds to different athletes within an athletic team, whereby the data set visually provides a tile viewable on the display screen and corresponding to each of the different athletes.
6. The system of examples 1, 2, 3, 4, or 5, wherein the first user is a coach of the at least one athlete, wherein the analytical athletic data further comprises at least one of: in-game management data or training and practice scenarios data.
7. The system of example 6, wherein the coach can view the analytical athletic data on the display screen while viewing a field of play of the athletic setting on which the at least one athlete is located.
8. A method for augmented reality sports data analytics, the method comprising:
   providing a computerized ocular device wearable by a first user, the computerized ocular device having a display screen configured to display a data set within a proximal field of view of the first user without fully obstructing a distal field of view of the first user;
   directing the distal field of view of the first user to an athletic setting, wherein at least one athlete is positioned within the athletic setting;
   sensing data with at least one sensor in communication with the computerized ocular device, wherein the data sensed corresponds to the at least one athlete;
   processing the data sensed in a computerized data processing system in communication with the computerized ocular device and the at least one sensor, wherein the data sensed by the at least one sensor is processed by the computerized data processing system to produce analytical athletic data; and
   populating the analytical athletic data into the data set on the display screen of the computerized ocular device, whereby the first user can visually identify the data set on the display screen.
9. The method of example 8, wherein the at least one sensor is positioned on or in the athletic setting, the at least one athlete, or a sporting implement.
10. The method of examples 8 or 9, wherein the at least one sensor is at least one of: a visual sensor, a movement or position sensor, a proximity sensor, a thermal sensor, or a biometric sensor.
11. The method of examples 8, 9, or 10, wherein the analytical athletic data further comprises at least one of: data about the at least one athlete, a sporting implement, a field of play within the athletic setting, an environmental condition which can affect a sporting event.
12. The method of examples 8, 9, 10, or 11, wherein the analytical athletic data corresponds to different athletes within an athletic team, whereby the data set visually provides a tile viewable on the display screen and corresponding to each of the different athletes.
13. The method of examples 8, 9, 10, 11, or 12, wherein the first user is a coach of the at least one athlete, wherein the analytical athletic data further comprises at least one of: in-game management data or training and practice scenarios data.
14. The method of example 13, wherein the coach can view the analytical athletic data on the display screen while viewing a field of play of the athletic setting on which the at least one athlete is located.
15. The method of examples 8, 9, 10, 11, 12, 13, or 14, further comprising:
   providing the at least one athlete with a second computerized ocular device wearable by the at least one athlete, the second computerized ocular device having a display screen configured to display a data set within a proximal field of view of the at least one athlete without fully obstructing a distal field of view of the at least one athlete; and
   sending at least one training exercise to the second computerized ocular device of the at least one athlete, wherein the at least one athlete visually sees a 3D model in the display screen of the second computerized ocular device, wherein the 3D model imitates an opponent of the at least one athlete.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. An augmented reality sports data analytics system comprising:
a computerized ocular device wearable by a first user, the computerized ocular device having a display screen configured to display a data set within a proximal field of view of the first user without fully obstructing a distal field of view of the first user;
an athletic setting within the distal field of view of the first user, wherein at least one athlete is positioned within the athletic setting;
at least one sensor in communication with the computerized ocular device, the at least one sensor sensing data corresponding to the at least one athlete; and
a computerized data processing system in communication with the computerized ocular device and the at least one sensor, wherein the data sensed by the at least one sensor is processed by the computerized data processing system to produce analytical athletic data, wherein the analytical athletic data is populated into the data set on the display screen of the computerized ocular device.

2. The system of claim 1, wherein the at least one sensor is positioned on or in the athletic setting, the at least one athlete, or a sporting implement.

3. The system of claim 1, wherein the at least one sensor is at least one of: a visual sensor, a movement or position sensor, a proximity sensor, a thermal sensor, or a biometric sensor.

4. The system of claim 1, wherein the analytical athletic data further comprises at least one of: data about the at least one athlete, a sporting implement, a field of play within the athletic setting, an environmental condition which can affect a sporting event.

5. The system of claim 1, wherein the analytical athletic data corresponds to different athletes within an athletic team, whereby the data set visually provides a tile viewable on the display screen and corresponding to each of the different athletes.

6. The system of claim 1, wherein the first user is a coach of the at least one athlete, wherein the analytical athletic data further comprises at least one of: in-game management data or training and practice scenarios data.

7. The system of claim 6, wherein the coach can view the analytical athletic data on the display screen while viewing a field of play of the athletic setting on which the at least one athlete is located.

8. A method for augmented reality sports data analytics, the method comprising:
providing a computerized ocular device wearable by a first user, the computerized ocular device having a display screen configured to display a data set within a proximal field of view of the first user without fully obstructing a distal field of view of the first user;
directing the distal field of view of the first user to an athletic setting, wherein at least one athlete is positioned within the athletic setting;
sensing data with at least one sensor in communication with the computerized ocular device, wherein the data sensed corresponds to the at least one athlete;
processing the data sensed in a computerized data processing system in communication with the computerized ocular device and the at least one sensor, wherein the data sensed by the at least one sensor is processed by the computerized data processing system to produce analytical athletic data; and
populating the analytical athletic data into the data set on the display screen of the computerized ocular device, whereby the first user can visually identify the data set on the display screen.

9. The method of claim 8, wherein the at least one sensor is positioned on or in the athletic setting, the at least one athlete, or a sporting implement.

10. The method of claim 8, wherein the at least one sensor is at least one of: a visual sensor, a movement or position sensor, a proximity sensor, a thermal sensor, or a biometric sensor.

11. The method of claim 8, wherein the analytical athletic data further comprises at least one of: data about the at least one athlete, a sporting implement, a field of play within the athletic setting, an environmental condition which can affect a sporting event.

12. The method of claim 8, wherein the analytical athletic data corresponds to different athletes within an athletic team, whereby the data set visually provides a tile viewable on the display screen and corresponding to each of the different athletes.

13. The method of claim 8, wherein the first user is a coach of the at least one athlete, wherein the analytical athletic data further comprises at least one of: in-game management data or training and practice scenarios data.

14. The method of claim 13, wherein the coach can view the analytical athletic data on the display screen while viewing a field of play of the athletic setting on which the at least one athlete is located.

15. The method of claim 8, further comprising:
providing the at least one athlete with a second computerized ocular device wearable by the at least one athlete, the second computerized ocular device having a display screen configured to display a data set within a proximal field of view of the at least one athlete without fully obstructing a distal field of view of the at least one athlete; and
sending at least one training exercise to the second computerized ocular device of the at least one athlete, wherein the at least one athlete visually sees a 3D model in the display screen of the second computerized ocular device, wherein the 3D model imitates an opponent of the at least one athlete.
